(19) United States
(12) Patent Application Publication
(10) Pub. No.: US 2010/0131998 A1
(43) Pub. Date: May 27, 2010

(54) Multimedia Frame Capture

(75) Inventor: Ke Yu, Alpharetta, GA (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/323,943

(22) Filed: Nov. 26, 2008

(51) Int. Cl. H04N 7/173; G06F 15/16; G06F 12/08; H04N 5/00

(52) U.S. Cl. 725/110; 709/219; 711/126; 386/121; 711/E12.016

(57) ABSTRACT

A method of communicating image capture commands is provided. The method includes receiving a user command to capture an image. The image to be captured is incorporated in multimedia content delivered by a multimedia distribution system via a network to an end-user device. The method further includes sending an image-capture command to the multimedia distribution system via the network in response to receiving the user command.

### FIELD OF THE DISCLOSURE

The present disclosure is generally related to a system and method of capturing and communicating multimedia data.

### BACKGROUND

Broadcast television provides a high degree of entertainment value but has limitations as compared to interactive media such as the internet. As such, various types of digital television with added interactive features have been proposed. One feature that is often requested is for a user to be able to capture images from displayed video. A particular system to capture images from displayed broadcast video involves adding special equipment to a stand-alone television device. The special equipment captures images of video after the video has been broadcast and received at the television device. Adding special, equipment to each television device would be expensive for consumers and would add significant operational costs for network providers, especially for deployment on a large scale.

### BRIEF DESCRIPTION OF THE DRAWINGS

FIG. 1 is a block diagram of a first particular embodiment of a multimedia distribution system;

FIG. 2 is a block diagram of a second embodiment of a multimedia distribution system;

FIG. 3 is a flow chart of a particular embodiment of a method of capturing and communicating image data;

FIG. 4 is a flow chart of a particular embodiment of a method of communicating image capture commands; and

FIG. 5 depicts an illustrative embodiment of a general computer system.

### DETAILED DESCRIPTION

In a particular embodiment, a method of communicating image capture commands is provided. The method includes receiving a user command to capture an image. The image to be captured is incorporated in multimedia content delivered by a multimedia distribution system via a network to an end-user device. The method further includes sending an image-capture command to the multimedia distribution system via the network in response to receiving the user command. The multimedia distribution system captures image data in response to the image-capture command and the image data may be stored or forwarded to a destination device.

In another particular embodiment, a computer-readable medium is disclosed. The computer-readable medium includes executable instructions that, when executed, cause a computer to buffer, at a device of a multimedia distribution system, image data of a multimedia-content stream to be sent to a receiver via a network and to access data from the device to generate captured image data in response to an image-capture request. An exemplary receiver is a set top box coupled to a display device.

In another embodiment a system is disclosed that includes a network-interface, a multimedia server, a buffering component, and an image-capturing component. The network interface is to communicate with a receiver via a network. The multimedia server is to send a multimedia-content stream to the receiver via the network-interface. The buffering component buffers image data of the multimedia-content stream, and the image-capturing component accesses data from the buffering component to generate captured image data in response to an image-capture request from the receiver.

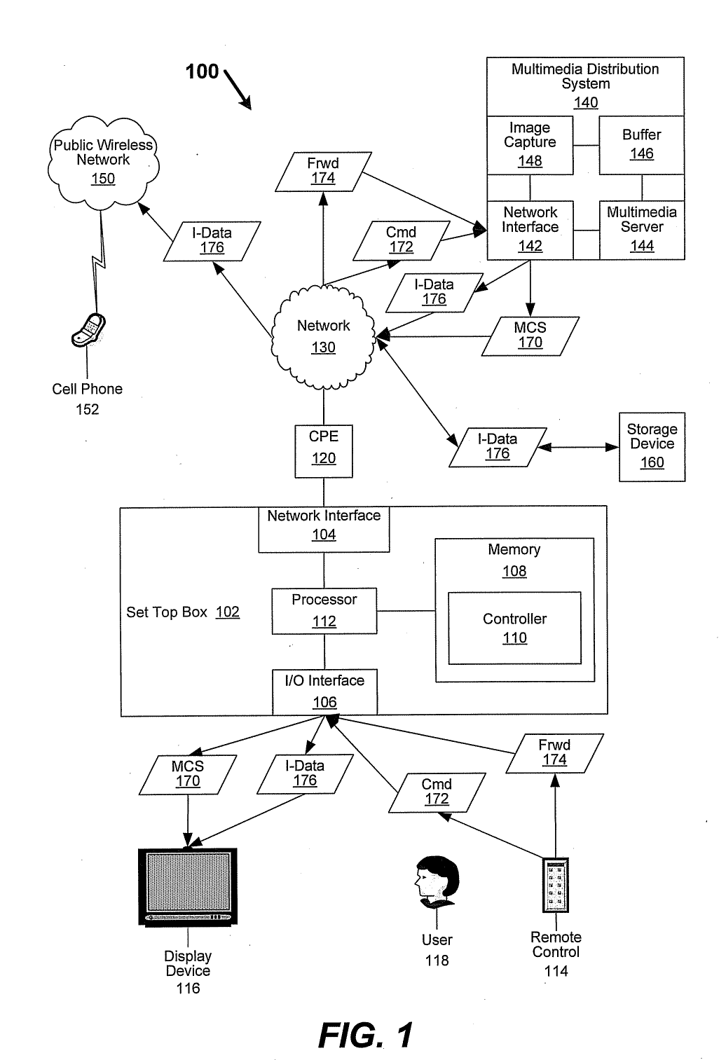

Referring to FIG. 1, a block diagram of a particular illustrative embodiment of a multimedia communication system is illustrated at 100. The system 100 includes a multimedia distribution system 140, a network 130, a wireless network 150, customer premises equipment (CPE) 120, and one or more end user devices, such as the illustrated set top box 102. The set top box 102 is coupled to a display device 116 and receives user input from a remote control device 114. The network 130 is coupled to a storage device 160. The multimedia distribution system 140 includes an image capture component 148, a data buffer 146, a network interface 142, and a multimedia server 144. The wireless network 150 may be a public wide area wireless network, such as a cellular network to communicate with end user wireless phones, such as cell phone 152 as illustrated.

The set top box 102 includes a network interface 104, a processor 112, an input/output (I/O) interface 106, and a memory 108. The memory 108 includes control logic, such as the illustrated controller functionality 110, or processor executable instructions, such as a computer program stored in the memory 108 to perform control functions.

During operation, a user 118 may use the remote control 114 to communicate a user command 172 to the set top box 102. An example of the user command 172 is a command to capture a frame of image data that is being displayed at the display device 116. The image data that is displayed at the display device 116 may be incorporated into a multimedia data stream that is communicated by the set top box 102 to the display device 116 for playback to the user 118. The multimedia data stream is illustrated as the multimedia content stream (MCS 170).

Upon receipt of the user command 172 at the I/O interface 106 of the set top box 102, the user command 172 is processed by the processor 112 and based on instructions from the controller 110 of the memory 108, the processor 112 processes the user command 172 and communicates an image capture command 172 via the network interface 104 to the multimedia distribution system 140 via the CPE 120 and the network 130. In a particular embodiment, the network is an internet protocol (IP) network and the multimedia distribution system 140 and the network 130 are part of an internet protocol television (IPTV) system. The multimedia distribution system 140 receives the image capture command, illustrated as command 172, from the network 130 at the network interface 142. The image capture component 148 of the multimedia distribution system 140 captures image data by retrieving multimedia data, such as image data from a multimedia stream, that is stored at the data buffer 146. The data buffer 146 stores multimedia data that is sourced from the multimedia server 144 over the network 130 to the set top box 102 for display at the display device 116. Thus, the buffer 146 temporarily stores data before such data is delivered and displayed at the display device 116 and the temporarily stored data is available for image capture by the image capture component 148. The captured image data from the image capture component 148 is communicated by the network interface 142, as image data (I-Data 176) via the network 130 and directed to the set top box 102. Once received at the set top box 102, the set top box 102 displays the image data (I-Data 176) at the display device 116. The user 118 views the captured image data 176 at the display device 116.

After the user has requested, received and views the captured image data 176, the user can interact with the set top box 102 and can request further actions to be taken with respect to the image data 176. For example, the user 118 can use the remote control 114 to send a forward command 174 to the set top box 102. The forward command 174 may be used to request the captured image 176 to be forwarded to another device. For example, the user 118 can request that the set top box 102 forward the image data 176 to a destination communication device, such as a destination cell phone 152, via the network 130 and the wireless network 150. Alternatively, the user 118 may request the image data 176 to be stored in a data storage device 160 by the network 130. The storage device 160 may function as a library for the user 118 to store multiple images or other data, such as stored video or audio. The library can be stored at the storage device 160 for multiple subscribers and can be offered as a service for users of set top boxes, such as the illustrated user 118. Thus, the user 118 can in real-time or near real-time, request a displayed video image to be captured, receive a displayed version of the captured image (e.g. a displayed image frame), and then can manipulate the image by taking actions such as forwarding the image to a selected destination device or storing the image at network attached storage for later access or use. The stored image data may be subsequently accessed for viewing or forwarded to alternative devices. An example of alternative devices includes mobile devices, such as a cell phone, network devices, such as a different set top box, or other electronic devices capable of displaying images.

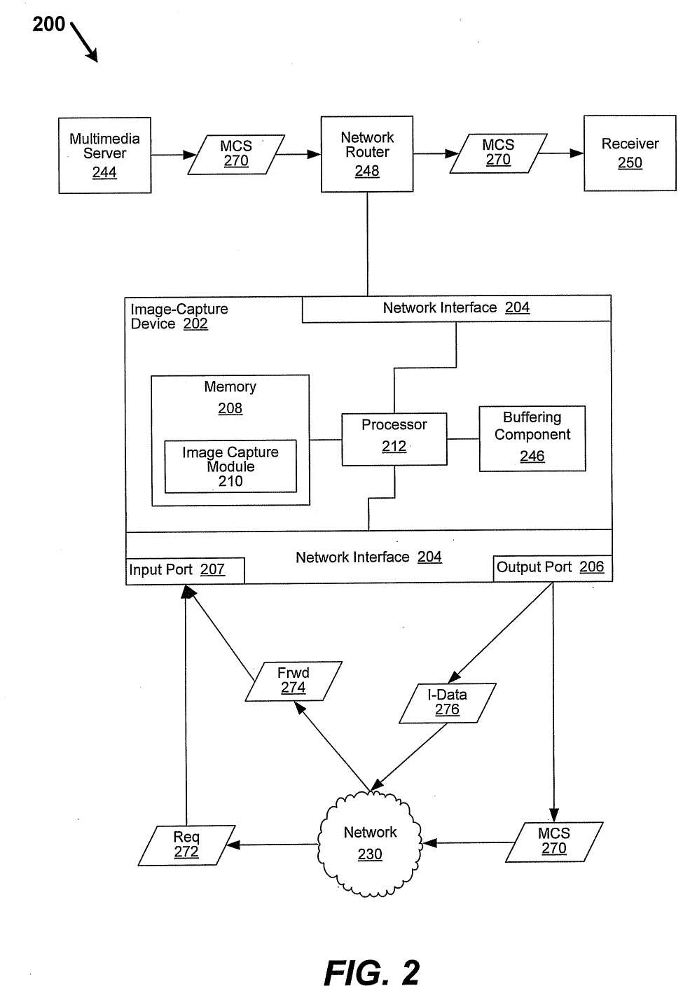

Referring to FIG. 2, an embodiment of a data communication system 200 is illustrated. The system 200 includes a multimedia server 244, an image-capture device 202, a network router 248, a receiver 250, and a network 230. The image-capture device 202 includes, a processor 212, a buffering component 246, a memory 208, and a network interface 204 that includes an input port 207 and an output port 206. The network interface 204 is configured to interface with the router 248. In a particular embodiment, the router 248 is part of the network 230. The memory 208 includes an image capture module 210. The image capture module 210 may be implemented as instructions that are executable by the processor 212. The image-capture device 202 is an example of equipment that may be used to implement functionality of the multimedia distribution system 140 illustrated in FIG. 1.

During operation, the router 248 receives a multimedia content stream 270 from the multimedia server 244. The multimedia content stream (MCS) 270 is routed by the router 248 to the receiver 250 and the MCS 270 is communicated for distribution to end user devices. In a particular embodiment, the router 248 is dedicated to multicasting. The network 230 is similar to the network 130 illustrated in FIG. 1. The image-capture device 202 buffers image data of the multimedia-content stream 270. In a particular embodiment, the image-capture device 202 buffers the image data based on network a propagation time between the video server 244 and the receiver 250, such as a set top box coupled to a television. The input port 207 of the image-capture device 202 is configured to receive an image capture request 272 that is communicated by the network 230. The image capture request 272 may be sent by the network 230 in response to a user request from an end user device that is coupled to the network 230. In response to receiving the request 272, the processor 212, responsive to the image capture module 210, retrieves captured image data from the buffering component 246. The captured image data is then available for distribution by the output port 206 of the image-capture device 202 as the illustrated image data (I-Data 276) sent via the network 230. The input port 207 may also receive a forward command 274 to request that a previously captured image, such as image data 276, be forwarded to a different device. The processor 212, in response to the forward command 274, directs communication of the image data 276 to a different device, such as a destination device addressable using the network 230. Examples of destination devices include network storage devices and end user devices, such as set top boxes, wireless devices, and other consumer electronic devices suitable for displaying image data. Thus, the image-capture device 202 includes embedded image capture and buffering capability to communicate via a network and to process and respond to image capture and forwarding commands related to multimedia content.

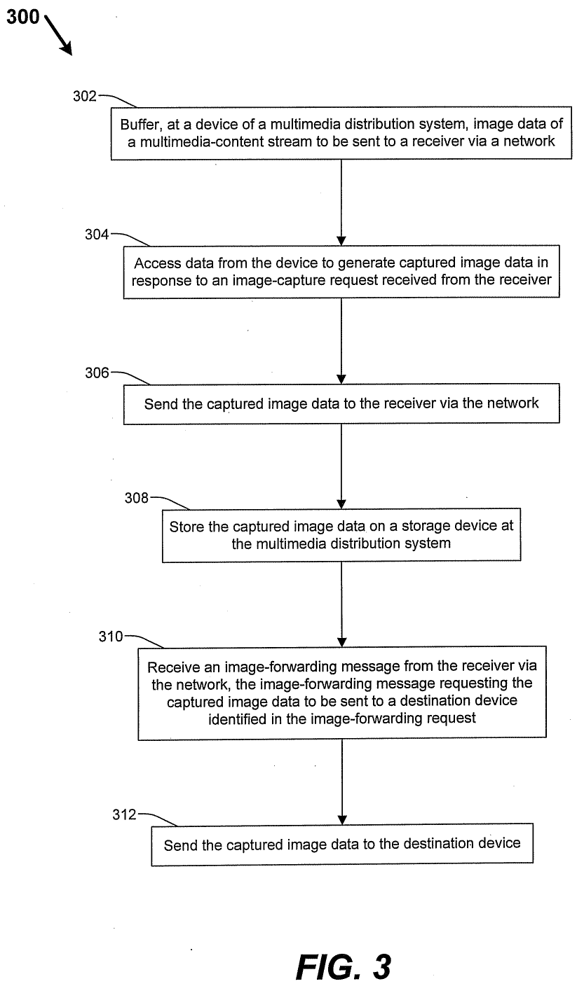

Referring to FIG. 3, a method of buffering data and responding to image capture commands is illustrated. The method includes buffering, at a device of a multimedia distribution system, image data of a multimedia content stream to be sent to a receiver (e.g. set top box 102) via a network, at 302, and accessing data from the device to generate captured image data in response to an image-capture request received from the receiver, as shown at 304. The method further includes sending the captured image data to the receiver via the network, as shown at 306. The captured image data may be stored, as shown at 308. The method further includes receiving an image-forwarding message from the receiver via the network, at 310. The image-forwarding message requests the captured image data to be sent to a destination device identified in the image-forwarding request. The destination device may be identified by an IP address or another type of address designation. The captured image data is then communicated to the destination device, as shown at 312.

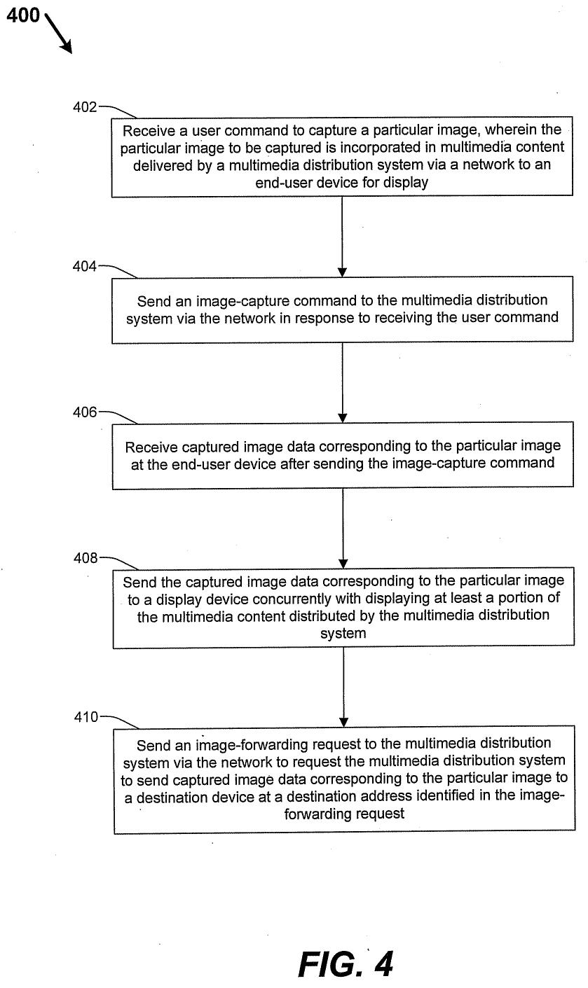

Referring to FIG. 4, a method of communicating captured image data in response to user commands is illustrated. The method includes receiving a user command to capture a particular image, at 402. The particular image to be captured is incorporated in multimedia content delivered by a multimedia distribution system via a network to one or more end-user devices for display. The method further includes sending an image-capture command to the multimedia distribution system via the network in response to receiving the user command, at 404, and receiving captured image data corresponding to the particular image at the end-user device after sending the image-capture command, at 406. The method further includes sending the captured image data corresponding to the particular image to a display device concurrently with displaying at least a portion of the multimedia content distributed by the multimedia distribution system, at 408. A picture in picture or other display method may be used to display a broadcast stream and the captured image at the display device. The method sends an image-forwarding request to the multimedia distribution system via the network to request the multimedia distribution system to send captured image data corresponding to the particular image to a destination device at a destination address identified in the image-forwarding request, at 410.

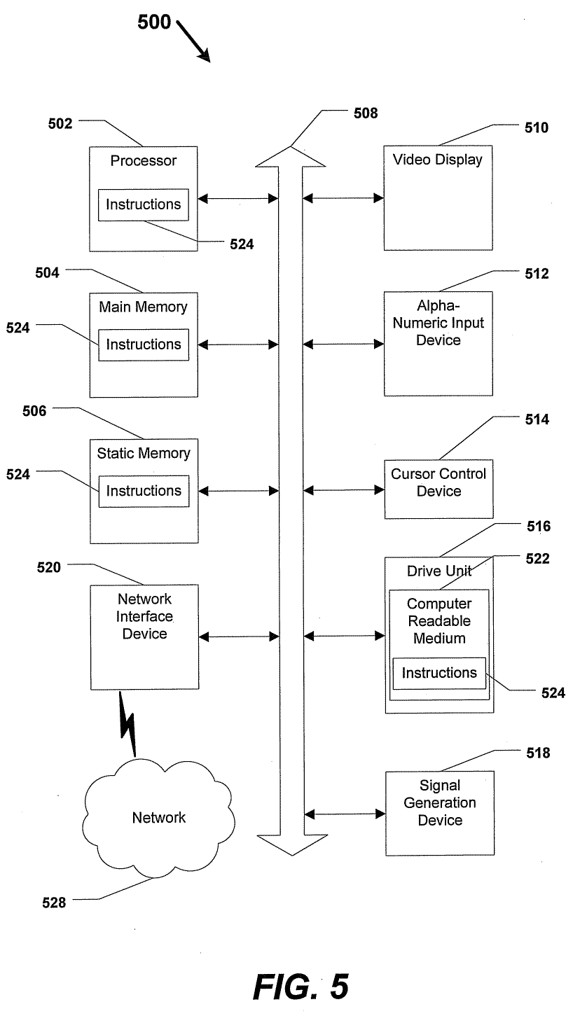

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices. For example, the general computer system 500 may include or be included within any one or more of the devices, (e.g. set top box) servers, repositories, and network elements illustrated in FIGS. 1 and 2.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a web appliance, or any other machine capable of executing a set of instructions (sequential or otherwise) that specify actions to be taken by that machine. In a particular embodiment, the computer system 500 can be implemented using electronic devices that provide video, audio or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), a flat panel display, a solid state display, a projection display, or a high definition television (HDTV) display. Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting exemplary embodiment, the computer-readable medium can include a solid-state memory, such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered equivalent to a tangible storage medium. Accordingly, the disclosure is considered to include any one or more of a computer-readable medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for digital multimedia files (e.g., standards from the Moving Pictures Experts Group (MPEG), among others) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a network-interface component to communicate with a receiver via a network;
a multimedia server to send a multimedia-content stream to the receiver via the network-interface component;
a buffering component to buffer image data of the multimedia-content stream; and
an image-capturing component to access data from the buffering component to generate captured image data in response to an image-capture request received from the receiver.

2. The system of claim 1, further comprising a router that includes the buffering component and the network-interface component.

3. The system of claim 1, further comprising a storage device to store the captured image data.

4. An image-capture device of a multimedia distribution system comprising:
a network interface configured to interface with a network router that sends a multimedia-content stream to a receiver via a network;
a buffering component configured to buffer image data of the multimedia-content stream;
an image-capturing component configured to receive an image-capture request and is configured to access data from the buffering component to generate captured image data in response to the received image-capture request.

5. The image-capture device of claim 4, wherein the receiver comprises a set top box.

6. The image-capture device of claim 4, wherein the network router is dedicated to multicasting.

7. The image-capture device of claim 4, wherein the multimedia distribution system is an element of an internet protocol television (IPTV) system.

8. The image-capture device of claim 4, wherein the buffering component is configured to buffer the image data based on a network propagation time between the multimedia distribution system and the receiver.

9. A method comprising:
buffering, at a device of a multimedia distribution system, image data of a multimedia-content stream to be sent to a receiver via a network; and
accessing data from the device to generate captured image data in response to an image-capture request received from the receiver.

10. The method of claim 8, further comprising:
sending the captured image data to the receiver via the network.

11. The method of claim 8, further comprising:
receiving an image-forwarding message from the receiver via the network, the image-forwarding message requesting the captured image data to be sent to a destination device identified in the image-forwarding request.

12. The method of claim 11, further comprising:
sending the captured image data to the destination device.

13. The method of claim 11, wherein the destination device comprises a mobile communication device.

14. The method of claim 8, further comprising:
storing the captured image data on a storage device at the multimedia distribution system.

15. A computer-readable medium comprising computer-executable instructions that, when executed, cause a computer to perform operations of:
buffering, at a device of a multimedia distribution system, image data of a multimedia-content stream to be sent to a receiver via a network; and
accessing data from the device to generate captured image data in response to an image-capture request received from the receiver.

16. The computer-readable medium of claim 15, wherein the operations include:
receiving an image-forwarding message from the receiver via the network, the image-forwarding message requesting the captured image data to be sent to a destination device identified in the image-forwarding message; and
sending the captured image data to the destination device.

17. The computer-readable medium of claim 16, wherein the device comprises a router and wherein the destination device comprises a mobile communication device.

18. A method comprising:
receiving a user command to capture a particular image, wherein the particular image to be captured is incorporated in multimedia content delivered by a multimedia distribution system via a network to an end-user device for display; and
sending an image-capture command to the multimedia distribution system via the network in response to receiving the user command.

19. The method of claim 18, further comprising:
receiving captured image data corresponding to the particular image at the end-user device after sending the image-capture command.

20. The method of claim 19, further comprising:
sending the captured image data corresponding to the particular image to a display device concurrently with displaying at least a portion of the multimedia content distributed by the multimedia distribution system.

21. The method of claim 18, further comprising:
sending an image-forwarding request to the multimedia distribution system via the network to request the multimedia distribution system to send captured image data corresponding to the particular image to a destination device at a destination address identified in the image-forwarding request.

22. The method of claim 21, wherein the destination device comprises a digital video recorder.
